(19) United States
(12) Patent Application Publication
(10) Pub. No.: US 2007/0006713 A1
(43) Pub. Date: Jan. 11, 2007

(54) Guitar pick package

(75) Inventor: Jim Dunlop, Benicia, CA (US)

Correspondence Address: Robert Charles Hill, #821, 235 Montgomery Street, San Francisco, CA, 94104, US

(73) Assignee: Dunlop Manufacturing, Inc.

(21) Appl. No.: 11/317,600

(22) Filed: Dec. 23, 2005

Related U.S. Application Data
(60) Provisional application No. 60/697,868, filed on Jul. 8, 2005.

(51) Int. Cl. G10D 3/16

(52) U.S. Cl. 84/322

(57) ABSTRACT

A guitar pick package comprises a single sheet of paper cardboard that is specially die-cut and folded to form a combination CD retaining pocket and guitar-pick retaining pocket album. Three major sections with three connecting folds provide a retaining pocket for a CD, a connection, and an album page with retaining pockets for several guitar picks. The guitar pick album page comprises three layers. A middle layer has cutouts that fit around the edges of each guitar pick, a back support retains the edges of the picks but allows them to be pressed out through a front retainer. The corresponding cutouts in the front retainer allow insertion and hold the points of the guitar picks.

### RELATED APPLICATIONS

Applicant claims priority from U.S. Provisional Patent Application, by the present inventor, Jim DUNLOP, titled GUITAR PICK PACKAGE, Ser. No. 60/697,868, with a filing date of Jul. 8, 2005. Such is incorporated herein by reference.

### BACKGROUND

1. Field of the Invention

The present invention relates to a package for guitar picks, and more particularly, to a guitar pick package which has a back support, a middle spacer cut out with guitar pick shapes, and a front retainer.

2. Description of the Prior Art

Guitar picks have become collector items and souvenirs for both musicians and fans. They can be printed with the artists' or bands' names, advertising, and other messages. A wide variety of styles and colors means that each collector would want a whole set or array, not just one. People who never owned a guitar or played one are nevertheless interested in receiving or buying them.

Many different prior art guitar pick packages are being marketed, such as plastic bags, clamshell packages, plastic boxes, and cardboard boxes. Conventionally, if marketed with a CD, the picks have just been tossed inside a CD package without a packaged presentation.

### SUMMARY OF THE INVENTION

Briefly, a guitar pick package embodiment of the present invention comprises a single sheet of paper cardboard that is specially die-cut and folded to form a combination CD retaining pocket and guitar-pick retaining pocket album. Three major sections with three connecting folds provide a retaining pocket for a CD, a connection, and an album page with retaining pockets for several guitar picks. The guitar pick album page comprises three layers. A middle layer has cutouts that fit around the edges of each guitar pick, a back support holds the edges of the picks and allows them to be pressed out through a front retainer. The corresponding cutouts in the front retainer allow insertion and hold the points of the guitar picks.

An advantage of the present invention is that a guitar pick package is provided which holds the picks in place for display.

Another advantage of the present invention is that a guitar pick package is provided that may have a CD included for combination sales.

A further advantage of the present invention is that a guitar pick package is provided that is inexpensive to manufacture.

A still further advantage of the present invention is that a guitar pick package is provided that is simple and easy to use.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a plan view diagram of a guitar pick package embodiment of the present invention after being die-cut from heavy paper and before being folded; and

FIGS. 2A-2F are assembly sequence diagrams of the guitar pick package of FIG. 1 in various states as it is being folded into its final shape.

### DETAILED DESCRIPTION OF THE PREFERRED EMBODIMENT

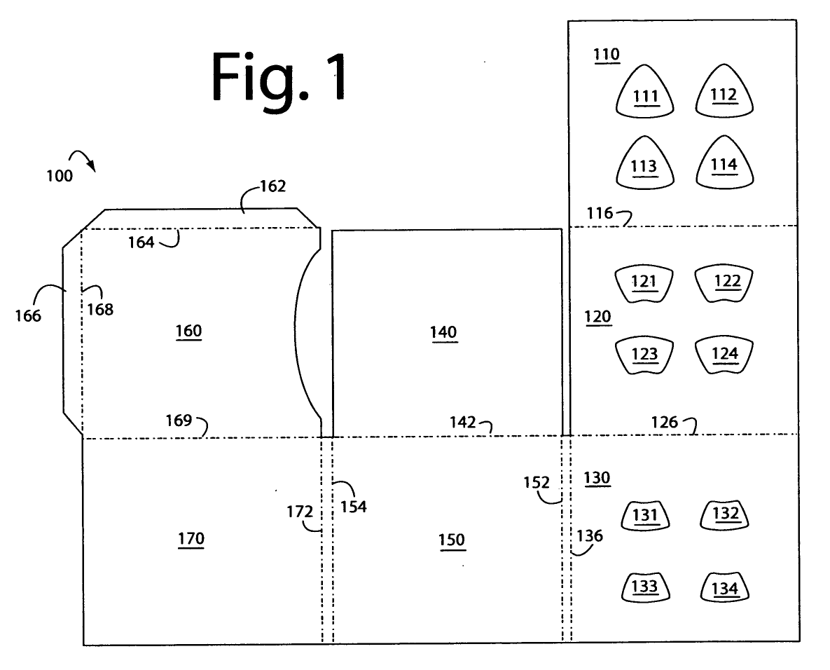

FIG. 1 represents a guitar pick package embodiment of the present invention, and is referred to herein by the general reference numeral 100. The guitar pick package 100 comprises a sheet of paper cardboard generally cut into the shape illustrated in FIG. 1. A number of folds and die cuts allow the guitar pick package 100 to be assembled into a consumer merchandizing package for a number of guitar picks and/or a compact disc (CD). A middle section 110 has four nesting cutouts 111-114 in the shape of a guitar pick to be enclosed. Here four such are shown to simplify the illustration, but one to nine such cutouts would be effective. The actual shapes of nesting cutouts 111-114 need to be customized because there are some shape variations in common picks. The thickness of middle section 110 would also need to be about the same as the thickness of the target guitar picks to be loaded inside.

A fold 116 allows nesting cutouts 111-114 to cover a back section 120 and to align with its rear-access cutouts 121-124. In combination, the pointy end of each guitar pick will be retained inside nesting cutouts 111-114 by a flap formed by the bottom edges of front-access cutouts 131-134.

A fold 126 allows cutouts 131-134 in front section 130 to cover middle section 110, which is over back section 120, and to align with cutouts 111-114 and 121-124, respectively. In combination, the whole of each guitar pick will be retained by cutouts 131-134 on the front, but still allowing a finger or small object access to press the picks through rear-access cutouts 121-124. This also prevents picks from falling out of the package. A fold 136 allows all of the above to be folded over the middle part of package 100 which includes a section 140, a fold 142, a section 150, and a fold 152 and 154.

The backside of section 150 will ultimately be visible to a consumer in a final configuration, and so it is a prime location to print with advertising or product information. The backside of section 140 will be visible to a consumer when the package 100 is unfolded, and so it is another good location to print with product information.

A section 160 is used to form a retaining pocket, for a CD or other disc. This is done by folding over section 162 along fold 164, and section 166 along fold 168, and then the whole across fold 169 to be joined with section 170. A fold 172 allows the package 100 to be folded so the backside of section 170 will be visible to the consumer in a merchandising display.

A valuable and useful product can be had without providing a retaining pocket for a CD. E.g., for simply selling or distributing guitar picks.

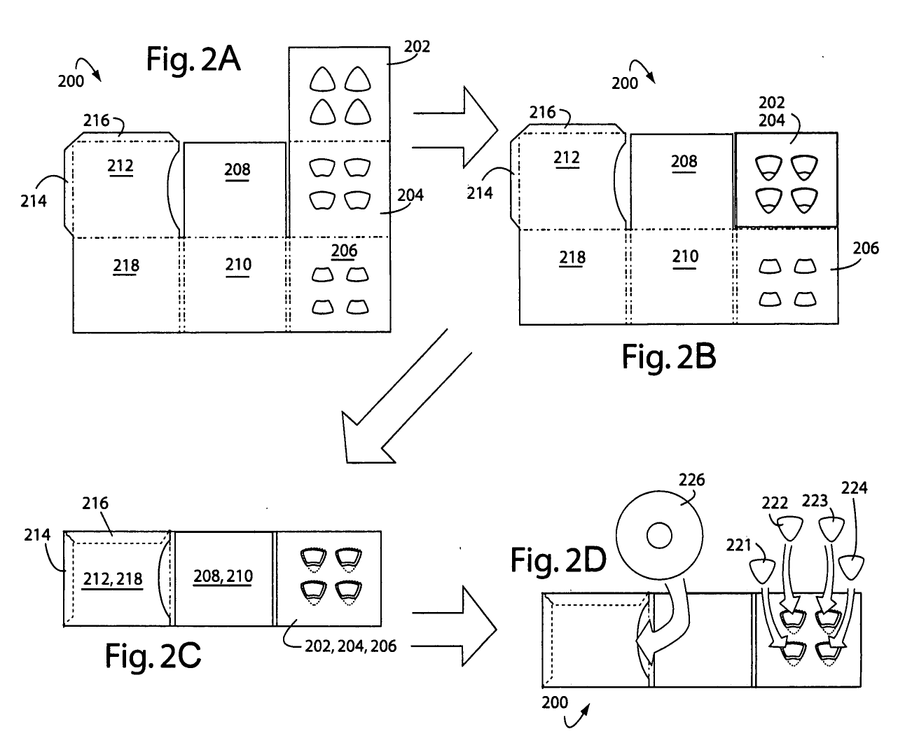

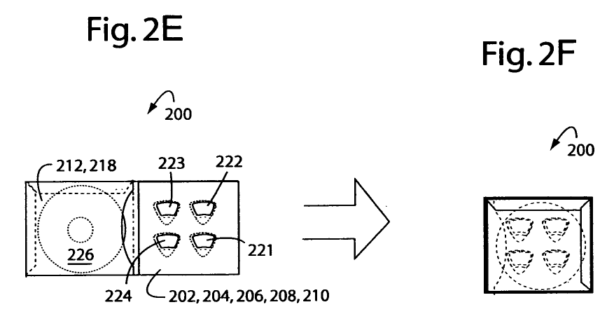

FIGS. 2A-2F illustrate a guitar pick package embodiment of the present invention being folded into a final product, which is referred to herein by the general reference numeral 200. A printed cardboard is die-cut to the shape shown in FIG. 2A. A pick middle section 202 is folded over a pick back section 204 and results in that shown in FIG. 2B.

A guitar-pick front section 206 is then folded over the middle section 202 and glued to result in that shown in FIG. 2C. Also in FIG. 2C, sections 210, and 218 are folded on top of sections 208 and 212 to result in that shown in FIG. 2D. A CD flap 212 in FIG. 2D has edge flaps 214 and 216 which are glued to outside cover 218 to produce that shown in FIG. 2C. In FIG. 2D, a number of guitar picks 221-224 are inserted through respective cutouts in front section 206. These are visible and accessible to being pressed back out by the cutouts in guitar-pick back section 204. A CD 226 can be included by inserting into the retaining pocket formed by flap 212. This results in a combination shown in FIG. 2E. One last fold, as in FIG. 2F, finishes the product.

In one instance, a guitar pick package embodiment of the present invention comprises a single piece of sheet material that can be cut and folded. A first part of the sheet material is folded to form overlapping first through third layers. At least one cutout in the first layer allows a guitar pick to be tilted in and fully inserted into the second layer. A corresponding number of cutouts are made in the second layer in the shape of the guitar pick. Such provide a nest all around the circumference of the guitar pick. A corresponding number of cutouts in the third layer are smaller in circumference than the guitar picks so they may not pass through, but still may be pressed back out through the first layer. A second part of the sheet material is folded and sealed along two orthogonal edges to form a retaining pocket retaining pocket for a disc. The sheet material is printed with product information and advertising related to the guitar pick. A guitar pick is inserted into a cutout in the second layer, and a disc inserted into the retaining pocket retaining pocket.

In general, guitar pick packages of the present invention include a back support member shaped like the pick to be held in place, but smaller than the pick in all dimensions. A middle member has an opening in the exact shape of the guitar pick. This opening overlaps the opening in the back support member. The front retainer member likewise has an opening in the exact shape of the guitar pick, except for a truncated bottom portion. This opening also overlaps the previous two openings. Thus, the opening in the front retainer member is larger than the opening in the back support member, but smaller than the opening in the middle member.

In use, each guitar pick is inserted into the overlapping openings with the tapered portion inserted first. After insertion, the pick will remain firmly in place, with the back of the pick resting against the back support member and the tapered portion of the pick nestled underneath the truncated bottom portion of the front retainer member. To remove the pick from the package, the user simply pushes through the opening in the back support member and pushes the pick forward. This allows the top of the pick to be grasped and pulled upward out of the package.

It should be understood that the guitar pick package of the present invention is not limited to any number of picks, or to any specific shape of pick, except that the three overlapping openings must correspond to the shape of the pick desired to be retained in the package.

Guitar pick packages are preferably formed from press board, paper board, or similar material. The guitar pick package can be of any suitable size, although when part of a CD package, should be the same size as the rest of the CD package. This allows the guitar pick package to fold between the front and back covers of the CD package.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A guitar pick package, comprising:
a sheet material that can be cut and folded;
a first part of the sheet material that is folded to form overlapping first through third layers;
at least one cutout in said first layer through which a guitar pick can be tilted in and fully inserted into said second layer;
a corresponding number of cutouts in said second layer in the shape of said guitar pick and providing for a nest all around the circumference of said guitar pick; and
a corresponding number of cutouts in said third layer smaller in circumference than said guitar pick so that it may not pass through but may be pressed back out through said first layer.

2. The guitar pick package of claim 1, further comprising:
a second part of the sheet material that is folded and sealed along two edges to form a retaining pocket for a disc.

3. The guitar pick package of claim 1, further comprising:
printing on the sheet material with product information and advertising related to said guitar pick.

4. The guitar pick package of claim 1, further comprising:
a guitar pick inserted into a cutout in said second layer.

5. The guitar pick package of claim 2, further comprising:
a disc inserted into said retaining pocket retaining pocket.

6. A guitar pick package, comprising:
a single piece of sheet material that can be cut and folded;
a first part of the sheet material that is folded to form overlapping first through third layers;
at least one cutout in said first layer through which a guitar pick can be tilted in and fully inserted into said second layer;
a corresponding number of cutouts in said second layer in the shape of said guitar pick and providing for a nest all around the circumference of said guitar pick;
a corresponding number of cutouts in said third layer smaller in circumference than said guitar pick so that it may not pass through but may be pressed back out through said first layer;
a second part of the sheet material that is folded and sealed along two orthogonal edges to form a retaining pocket retaining pocket for a disc;
printing on the sheet material with product information and advertising related to said guitar pick.
a guitar pick inserted into a cutout in said second layer; and
a disc inserted into said retaining pocket retaining pocket.
